(19) United States
(12) Patent Application Publication
(10) Pub. No.: US 2024/0186740 A1
(43) Pub. Date: Jun. 6, 2024

(54) Contacts, Connectors and Connector Assemblies

(71) Applicant: Tyco Electronics Japan G.K., Kawasaki-shi (JP)

(72) Inventor: Ming Jiang, Kawasaki-shi (JP)

(73) Assignee: Tyco Electronics Japan G.K., Kawasaki-shi (JP)

(21) Appl. No.: 18/531,106

(22) Filed: Dec. 6, 2023

(30) Foreign Application Priority Data
Dec. 6, 2022 (JP) 2022-194865

(51) Int. Cl. H01R 13/504; H01R 12/70; H01R 12/71; H01R 13/05

(52) U.S. Cl. CPC H01R 13/5045; H01R 12/7064; H01R 12/716; H01R 13/055

(57) ABSTRACT

A contact comprises a press-fitting portion, a pushing protrusion and a first widened region. The press-fitting portion is adapted to be press-fitted to a press-fitting target in a press-fitting direction. The pushing protrusion projects out to one side in a width direction intersecting the press-fitting direction on a back side of the press-fitting portion in the press-fitting direction. The pushing protrusion projects out beyond a position of the press-fitting portion to the one side in the width direction. A pushing surface on the back side of the pushing protrusion is opened to the back side in the press-fitting direction. The first widened width region continues on the back side of the pushing protrusion, is located closer to another other side in the width direction with respect to the press-fitting portion, and is wider in the width direction than the press-fitting portion.

### CROSS-REFERENCE TO RELATED APPLICATION

This application claims the benefit of Japanese Patent Application No. 2022-194865 filed on Dec. 6, 2022, the whole disclosure of which is incorporated herein by reference.

### FIELD OF THE INVENTION

The present invention relates to a contact, a connector including the contact, and a connector assembly including the connector.

### BACKGROUND

A so-called floating type connector assembly can be used for mechanical connection and electrical connection between configuring parts positioned in various electronic equipment. Such a connector assembly includes, for example, a first connector including a contact joined to a first circuit board, and a second connector including a contact joined to a second circuit board. The first connector and the second connector are configured to be able to mate even if relatively position shifted within a predetermined floating range as the bent contact elastically deforms so that problems do not arise in the assembly of the first circuit board and the second circuit board due to tolerance in assembly and furthermore, for stable connection at the time of vibration.

A socket connector of the prior art includes a lower shell, an upper shell inserted to the inner side of the lower shell from above, and a plurality of socket contacts retained by the lower shell and the upper shell, and is mated with a plug type connector. Each of the socket contacts is shaped to a shape having a plurality of curved portions, and is retained by the lower shell and the upper shell. The upper shell is assembled to the lower shell by engaging with a metal fitting. The metal fitting is joined to the circuit board to reinforce the joining between the socket contact and the circuit board.

A contact of the above socket connector is shaped by processing of punching and bending. The contact includes a first retaining portion press-fitted to the lower shell, and a second retaining portion press-fitted to the upper shell. The contact is bent to a predetermined shape between the first retaining portion and the second retaining portion. The contact used in the floating type connector includes that which is bent to a complex shape. With the pitches of the contacts becoming denser as a background, it is difficult to satisfy both manufacturing property of the contact and impedance matching of a transmission path.

### SUMMARY

According to an embodiment of the present disclosure, a contact comprises a press-fitting portion, a pushing protrusion and a first widened region. The press-fitting portion is adapted to be press-fitted to a press-fitting target in a press-fitting direction. The pushing protrusion projects out to one side in a width direction intersecting the press-fitting direction on a back side of the press-fitting portion in the press-fitting direction. The pushing protrusion projects out beyond a position of the press-fitting portion to the one side in the width direction. A pushing surface on the back side of the pushing protrusion is opened to the back side in the press-fitting direction. The first widened width region continues on the back side of the pushing protrusion and is located closer to another other side in the width direction with respect to the press-fitting portion. The first widened width region is wider in the width direction than the press-fitting portion.

### BRIEF DESCRIPTION OF THE DRAWINGS

The invention will now be described by way of example with reference to the accompanying Figures, of which:

FIG. 1(a) is an isometric view illustrating a connector assembly according to an embodiment of the present invention, the connector assembly including a first connector and a second connector.

FIG. 1(b) is a cross sectional view taken along line Ib-Ib of FIG. 1(a).

FIG. 2(a) is an isometric view illustrating the first connector.

FIG. 2(b) is a cross sectional view taken along line IIb-IIb of FIG. 2(a).

FIG. 3 is an exploded isometric view of the first connector (excluding ground contact connecting element).

FIG. 4 is an isometric view illustrating a fixed housing of the first connector.

FIG. 5(a) is an isometric view showing a movable housing of the first connector.

FIG. 5(b) is a partially enlarged front view of a guide protrusion.

FIG. 5(c) is a partially enlarged side view of the guide protrusion.

FIG. 6 is a cross sectional view taken along line VI-VI of FIG. 1(a), and is a view showing a first gap set between the fixed housing and the movable housing in a first direction.

FIG. 7 is a bottom view illustrating from a direction of an arrow VII of FIG. 1(a), and is a view showing a second gap set between the fixed housing and the movable housing in a second direction.

FIG. 8(a) is a side view of the first contact.

FIG. 8(b) is an isometric view of the first contact.

FIG. 8(c) is a front view of the first contact.

FIG. 9 is a developed top view illustrating a configuration of a movable retaining portion of the first contact and the details in the vicinity thereof.

FIG. 10(a) is a diagram describing the movable retaining portion being inserted and press-fitted to the retaining groove of the movable housing.

FIG. 10(b) is a diagram illustrating the pushing surface of the movable retaining portion from an arrow Xb of FIG. 10(a).

FIG. 11 is a diagram illustrating a configuration of a fixing retaining portion of the first contact and the details in the vicinity thereof from a direction of an arrow XI of FIG. 8(b).

FIG. 12 is a isometric view of a ground contact connecting element.

FIG. 13 is a bottom view of the ground contact connecting element and the first contact.

FIG. 14(a) is a partially broken isometric view of a second connector.

FIG. 14(b) is a lateral cross sectional view of FIG. 14(a).

FIG. 15 is an exploded isometric view of the second connector.

FIG. 16 is a cross sectional view illustrating the first connector and the second connector before mating.

FIG. 17 is a cross sectional view illustrating a state in which the contact is elastically deformed in the first direction at the time of mating of the first connector and the second connector.

FIG. 18 is a top view illustrating a state in which the contact is elastically deformed in the first direction and the second direction at the time of mating of the first connector and the second connector.

FIG. 19 is a graph describing advantages of the ground contact connecting element.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### [Overall Configuration]

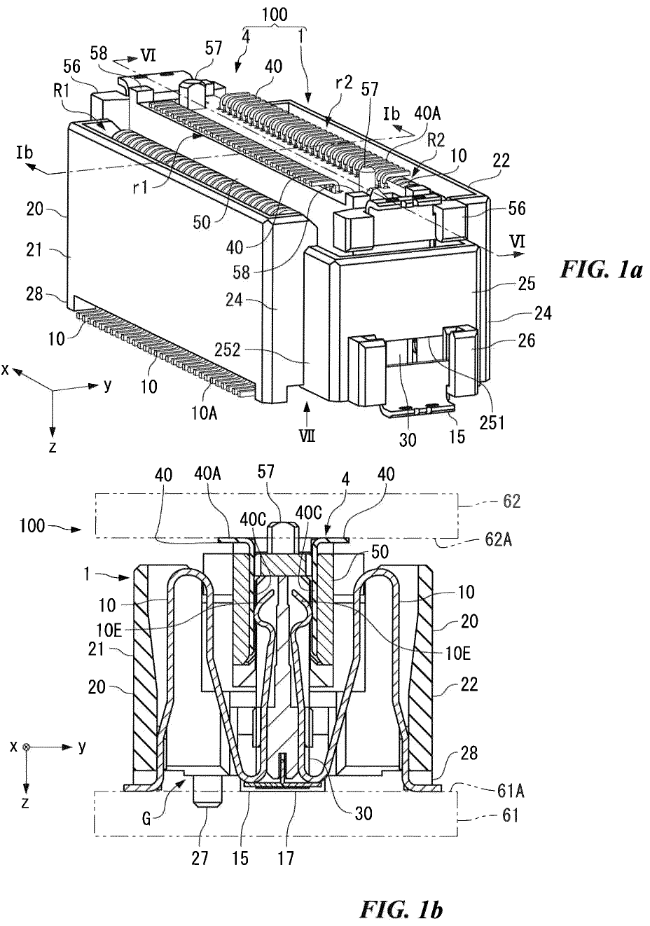

A connector assembly 100 illustrated in FIGS. 1(a) and 1(b) includes a first connector 1 and a second connector 4 mated with each other, and is used for mechanical connection and electrical connection between circuit boards positioned in various electronic equipment. First, a configuration of an outline of the first connector 1 and the second connector 4 will be described. The first connector 1 includes a plurality of first contacts 10, and a fixed housing 20 and a movable housing 30 that retain the plurality of first contacts 10. The plurality of first contacts 10 are joined to a first circuit board 61 serving as a joining target. The first contacts 10 are positioned along a predetermined first direction x to form a first row R1 and a second row R2 in parallel, and are positioned on a first mounting surface 61A of the first circuit board 61.

The second connector 4 includes a plurality of second contacts 40, and a housing 50 that retains the plurality of second contacts 40. The plurality of second contacts 40 are joined to a second circuit board 62. The second contacts 40 are also positioned to form a first row r1 and a second row r2 in parallel, and are positioned on a second mounting surface 62A of the second circuit board 62, similarly to the first contact 10. When the first connector 1 and the second connector 4 are mated, the first contact 10 in the first row R1 is electrically connected individually to the second contact 40 in the first row r1, and the first contact 10 in the second row R2 is electrically connected individually to the second contact 40 in the second row r2.

The first connector 1 and the second connector 4 are mated in a mating direction z orthogonal to the first mounting surface 61A and the second mounting surface 62A in a state where the first circuit board 61 and the second circuit board 62 are positioned in parallel. The first mounting surface 61A includes a first direction x, and s second direction y orthogonal to the first direction x and the mating direction z. This also applies to the second mounting surface 62A.

In the present specification, the first circuit board 61 side in the mating direction z is referred to as the lower side, and a side opposite to the first circuit board 61 in the mating direction z is referred to as the upper side.

As will be described later, the first connector 1 of the present embodiment allows relative displacement between the first circuit board 61 and the second circuit board 62 over a floating range corresponding to a dimension of a gap set in the first direction x and the second direction y, respectively, between the fixed housing 20 and the movable housing 30.

### [Configuration of First Connector]

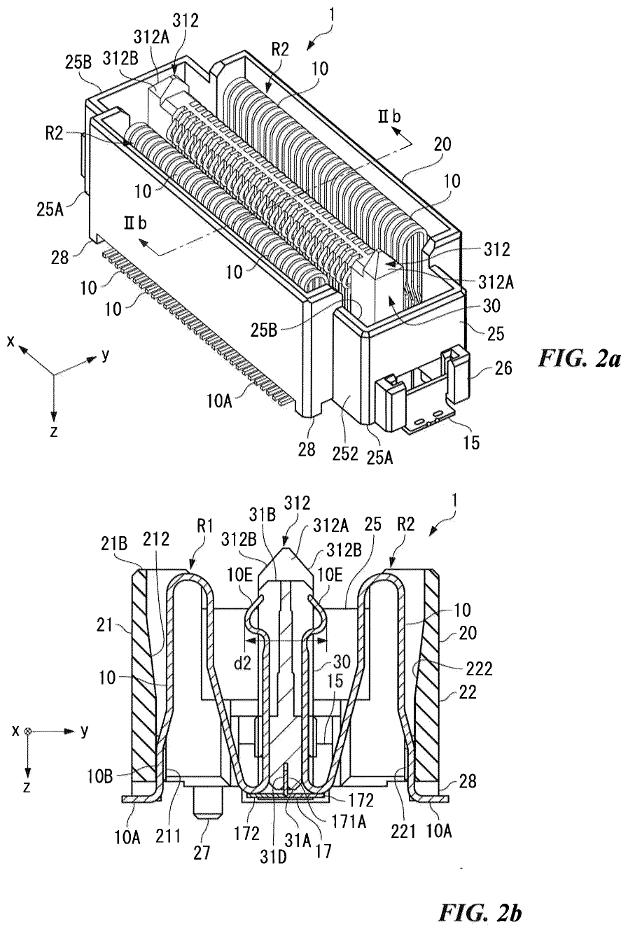

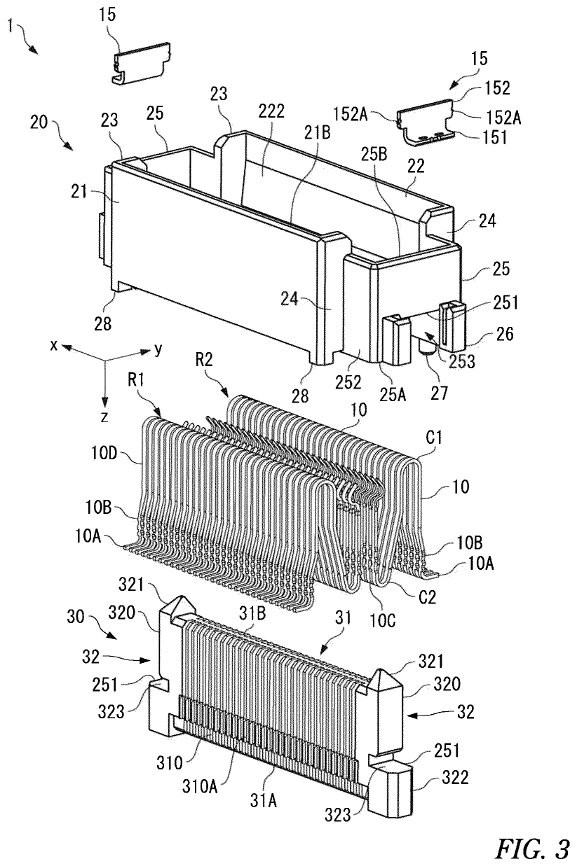

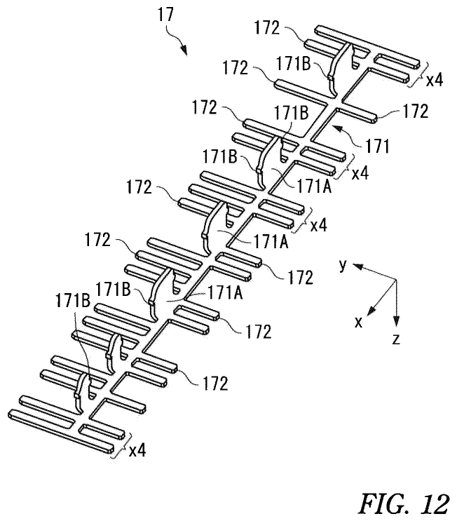

As illustrated in FIGS. 2(a), 2(b) and 3, the first connector 1 includes a plurality of first contacts 10, a fixed housing 20, and a movable housing 30 positioned so as to be relatively displaceable with respect to the fixed housing 20. Furthermore, the first connector 1 preferably includes a housing joining element 15 that joins the fixed housing 20 to the first circuit board 61, and a ground contact connecting element 17 (FIG. 12) that comes into contact with some contacts 10. Note that in some drawings, illustration of the ground contact connecting element 17 is omitted. The fixed housing 20 is integrally formed by injection molding using resin material having insulating property. This is similar in the movable housing 30.

The first contact 10 of the first row R1 and the first contact 10 of the second row R2 are respectively positioned at an equal pitch in the first direction x and adjacently positioned in the second direction y. In the present embodiment, the first contact 10 of the first row R1 and the first contact 10 of the second row R2 are arrayed such that the positions in the first direction x coincide. This is not the sole case, and the first contact 10 of the first row R1 and the first contact 10 of the second row R2 may be arrayed shifted in the first direction x by the dimension of ½ of the pitch.

### (Fixed Housing)

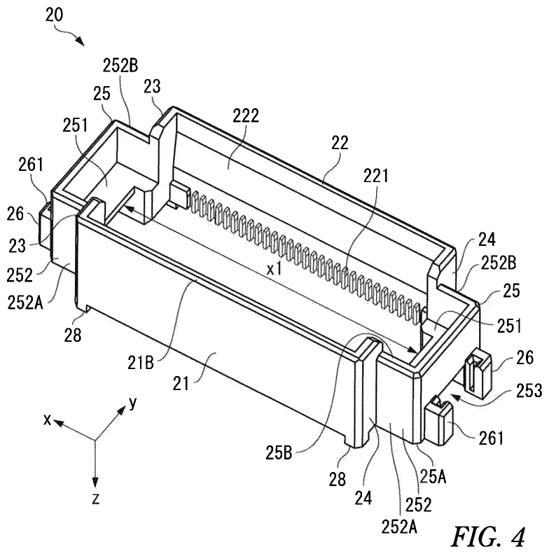

As illustrated in FIG. 4, the fixed housing 20 includes side walls 21, 22 and partial walls 23, 24 that surround the plurality of first contacts 10 and are positioned on the first mounting surface 61A, an expansion wall 25 formed on both sides of the fixed housing 20 in the first direction x to project out in the first direction x to the outer side of the partial walls 23, 24, a joining element retaining portion 26 that retains the housing joining element 15, a locating boss 27 inserted into a hole (not illustrated) formed in the first circuit board 61, and a leg portion 28 positioned on the first mounting surface 61A. In some drawings, the illustration of the boss 27 is omitted.

The side walls 21, 22 extend in the first direction x in which the first contacts 10 are arrayed, and face each other in the second direction y. The partial walls 23, 24 orthogonal to the side walls 21, 22 are positioned on both sides of the second direction y between the side walls 21, 22, and are continued with the expansion wall 25. A space having a rectangular shape in top view in which the first contacts 10 are positioned is formed on the inner side of the walls 21 to 24. The leg portion 28 is formed at lower ends of four corners forming the walls 21 to 24. The side walls 21, 22 and the partial walls 23, 24 are raised with respect to the mounting surface 61A from the respective lower ends (e.g., 21A) to the upper end (e.g., 21B) slightly beyond the first contact 10. A gap G (FIG. 1(b)) is formed between the lower ends of the walls 21 to 24 and the first mounting surface 61A.

A retaining groove 211 to which the first contact 10 of the first row R1 is press-fitted is formed at the same pitch as the first contact 10 near the lower end of the inner side of the side wall 21. Similarly, a retaining groove 221 to which the first contact 10 of the second row R2 is press-fitted is formed at the same pitch as the first contact 10 near the lower end of the inner side of the side wall 22. A chamfered portion 212 is formed on the upper side of the retaining groove 211 on the inner side of the side wall 21 to avoid interference between the first contact 10 and the fixed housing 20. The chamfered portion 212 is formed from the position above the retaining groove 221 to the position near the upper end 21B of the side wall 21. The chamfered portion 212 is inclined with respect to the mating direction z in a direction of separating in the second direction y with respect to a first zone 101 of the first contact 10 as it approaches a first curved portion C1 from a fixing retaining portion 10B. A chamfered portion 222 similar to the chamfered portion 212 is formed on the inner side of the side wall 22.

The expansion wall 25 is formed to a rectangular shape in top view by a wall raised in the mating direction z from the lower end 25A to the upper end 25B. The upper end 25B is lower than the upper end 21B of the side wall 21 and the upper end 31B of the movable housing 30. The expansion wall 25 contributes to assembly of the fixed housing 20 and the movable housing 30 while receiving a part of each of the movable housing 30 and the second connector 4 on the inner side on both sides of the fixed housing 20 in the first direction x. Furthermore, the expansion wall 25 sets a floating range by setting a gap between the fixed housing 20 and the movable housing 30. The expansion wall 25 is preferably formed symmetrically in the first direction x with the walls 21 to 24 in between.

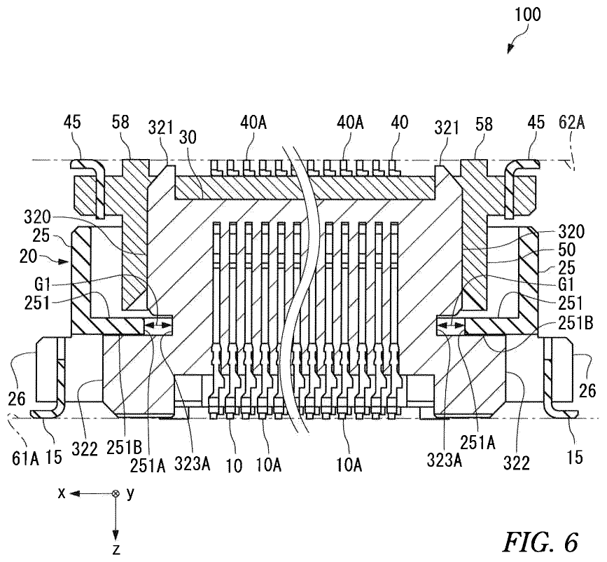

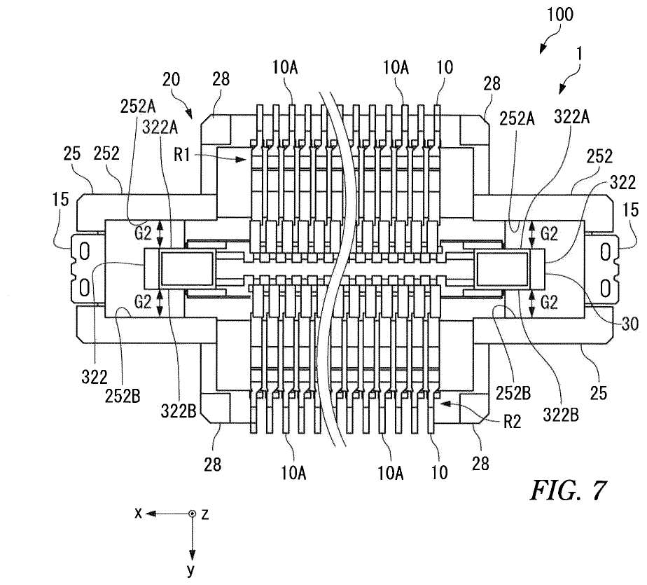

As illustrated in FIGS. 6 and 7, the expansion wall 25 is formed with opposing portions 251 positioned facing each other toward the first mounting surface 61A on the inner side of the fixed housing 20. The opposing portion 251 sets a first gap G1 in the first direction x between the fixed housing 20 and the movable housing 30. The opposing portion 251 is extended in the first direction x and the second direction y and formed to a plate shape, and is supported by the wall of the expansion wall 25. As will be understood from FIG. 4, the opposing portion 251 of the present embodiment is formed to a substantially C-shape in top view. A predetermined dimension x1 is given between the opposing portion 251 on one end side and the opposing portion 251 on the other end side in the first direction x.

The housing 50 of the second connector 4 is positioned above the opposing portion 251 on the inner side of the expansion wall 25. The lower side of the opposing portion 251 of the expansion wall 25 corresponds to a lower region 252 (FIG. 4) that sets a second gap G2 in the second direction y between the fixed housing 20 and the movable housing 30. The lower region 252 includes side walls 252A, 252B extending in the first direction x and the mating direction z on the lower side of the opposing portion 251.

The joining element retaining portion 26 is provided on the expansion wall 25 on both sides of the fixed housing 20 in the first direction x, and retains the housing joining element 15 illustrated in FIG. 3. The housing joining element 15 includes a joining portion 151 joined to the first circuit board 61 by a solder (not illustrated), and a press-fitting portion 152 having protrusions 152A on both sides. The joining element retaining portion 26 has a pair of grooves 261 for retaining the housing joining element 15 press-fitted from above along the mating direction z. An opening 253 is formed on the lower side of the opposing portion 251 in the expansion wall 25 and between the pair of grooves 261. Note that the opening 253 may not be formed in the expansion wall 25.

As illustrated in FIGS. 2(b) and 3, the fixed housing 20 includes two pin-like bosses 27. The two bosses 27 project out in the mating direction z from the lower ends of the side walls 21, 22 or the partial walls 23, 24, and are spaced apart from each other in both the first direction x and the second direction y. The size of the diameter of the bosses 27 is different. Thus, the first connector 1 can be attached to the first circuit board 61 in a correct direction in which the two bosses 27 can be inserted to the holes of the first circuit board 61.

### (Movable Housing)

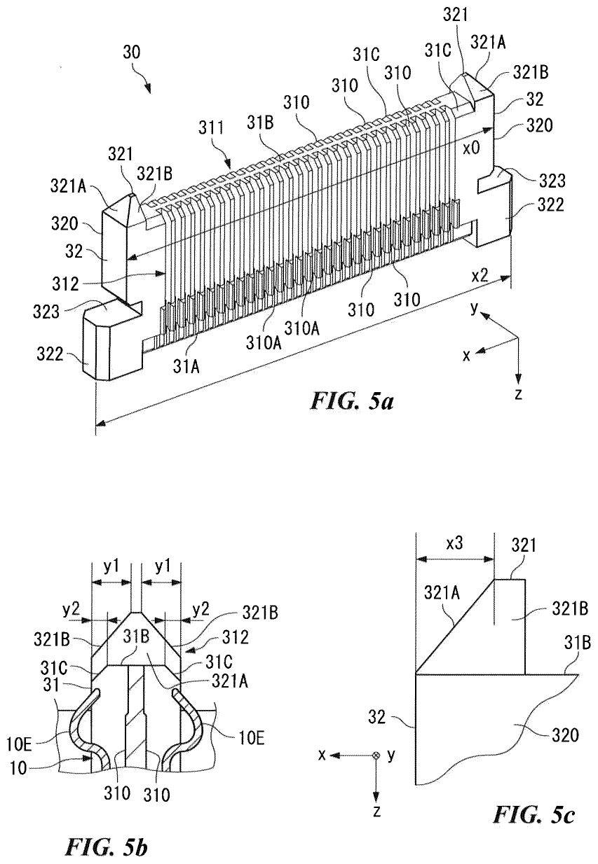

As illustrated in FIGS. 2(a), 2(b) and 5(a), the movable housing 30 divides the inner side of the fixed housing 20 to the first row R1 side and the second row R2 side, and retains the first contact 10 of the first row R1 and the contact 10 of the second row R2 together with the fixed housing 20. The movable housing 30 includes a retaining region 31 that extends in the first direction x at a length corresponding to the length of the rows R1, R2 and retains the first contact 10, and an expansion region 32 that is continued to both sides of the retaining region 31 in the first direction x, and is related to locating with respect to the second connector 4, assembly with the fixed housing 20, and setting of the floating range.

The retaining region 31 is given a width (dimension in the second direction y) and a height (dimension in the mating direction z) necessary for retaining the first contact 10 of the first row R1 and the first contact 10 of the second row R2. In the side surface 311 on the first row R1 side and the side surface 312 on the second row R2 side of the retaining region 31, a plurality of grooves 310 where each of the first contacts 10 is positioned are formed along the mating direction z. A guide inclined surface 31C for locating the movable housing 30 in the second direction y with respect to the second contact 40 of the second connector 4 is formed on the first row R1 side and the second row R2 side in the upper end 31B of the retaining region 31.

The groove 310 includes a retaining groove 310A to which the first contact 10 is press-fit, and is continued over the entire height of the side surfaces 311, 312 as the entire groove 310. The grooves 310 are arrayed in the first direction x at a constant pitch. The depth (dimension in the second direction y) of the groove 310 changes in the mating direction z, as illustrated in FIG. 2(b). The retaining groove 310A is formed in the vicinity of the lower end 31A of the retaining region 31.

A ground retaining groove 31D (FIG. 2(b)) to which the ground contact connecting element 17 is press-fit is formed in the lower end 31A of the retaining region 31. In the retaining region 31, a plurality of ground retaining grooves 31D depressed toward the upper side from the lower end 31A are interspersed in the first direction x.

The expansion region 32 includes an upper part 320 formed with a guide protrusion 321 positioned on the upper side than the upper end 31B of the side surface 311, 312, and a lower part 322 positioned on a lower side than an opposing portion 251 of the fixed housing 20. The expansion region 32 is preferably formed symmetrically in the first direction x with the retaining region 31 in between.

The expansion region 32 is formed with a concave portion 323 depressed in the first direction x at a position corresponding to the opposing portion 251. The upper part 320 and the lower part 322 are divided by the concave portion 323. The dimension in the mating direction z of the inner side of the concave portion 323 is the same as or larger than the plate thickness of the opposing portion 251. The opposing portion 251 is inserted to the inner side of the concave portion 323 depending on the relative position of the movable housing 30 and the fixed housing 20. The opposing portion 251 can be received in the concave portion 323 with the abutment of an end face 251A of the opposing portion 251 on a far surface 323A of the concave portion 323 as the limit.

The guide protrusion 321 comes into contact with the housing 50 before the guide inclined surface 31C comes into contact with the housing 50 or the second contact 40 of the second connector 4, and guides the movable housing 30 in the first direction x and the second direction y following the position of the housing 50. Thus, the guide protrusion 321 is formed with an inclined surface 321A inclined with respect to the yz plane and an inclined surface 321B inclined with respect to the xz plane.

As illustrated in FIG. 5(b), a guide range y1 in which the movable housing 30 is displaceable in the second direction y by the guide from the inclined surface 321B is set for the inclined surface 321B of the guide protrusion 321. The guide range y1 is wider than the guide range y2 in which the movable housing 30 is displaceable in the second direction y by the guide from the guide inclined surface 31C. In addition, as illustrated in FIG. 5(c), a guide range x3 in which the movable housing 30 is displaceable in the first direction x by the guide from the inclined surface 321A is set for the inclined surface 321A of the guide protrusion 321.

The dimension x0 (FIG. 5(a)) in the first direction x of the upper part 320 is small with respect to the dimension x1 (FIG. 4) between the opposing portions 251 on both sides. On the other hand, the dimension x2 (FIG. 5(a)) in the first direction x of the lower part 322 is large with respect to the dimension x1 (FIG. 4) between the opposing portions 251 on both sides. Thus, as illustrated in FIG. 6, the movable housing 30 can be inserted to the inner side of the fixed housing 20 from below until the lower part 322 abuts on a lower surface 251B of the opposing portion 251. At this time, the upper part 320 is accommodated in the fixed housing 20 up to a position beyond the opposing portion 251 on the upper side. The upper part 320 is mated with the housing 50 of the second connector 4. The housing 50 is positioned to surround the upper part 320 on the inner side of the fixed housing 20.

When the first contact 10 and the housing joining element 15 are joined to the first circuit board 61 and the fixed housing 20 is fixed to the first circuit board 61, the lower part 322 is positioned between the opposing portion 251 and the first mounting surface 61A of the first circuit board 61. Since the lower part 322 is sandwiched in the mating direction z by the opposing portion 251 and the first circuit board 61, the movable housing 30 is assembled to the fixed housing 20 and the first circuit board 61 in a state of not separating to the upper side and the lower side. Thus, the first connector 1 does not need to have a fixing metal fitting and the like for assembling the movable housing 30, the fixed housing 20, and the first circuit board 61, and the movable housing 30 and the fixed housing 20 are not restricted by such a fixing metal fitting and the like.

As illustrated in FIG. 6, on both sides of the first connector 1 in the first direction x, a first gap G1 having a predetermined dimension is set between the end face 251A of the opposing portion 251 and the far surface 323A of the concave portion 323. In FIG. 6, a state in which the respective centers of the fixed housing 20 and the movable housing 30 in the first direction x coincide is illustrated. The relative displacement in the first direction x of the movable housing 30 to the right side or the left side of FIG. 6 with respect to the fixed housing 20 from this state is allowed with the dimension of the first gap G1 as the limit. For example, when the first gap G1 is 1 mm, a floating range of +1 mm in the first direction x is given to the first connector 1.

Furthermore, as illustrated in FIG. 7, a second gap G2 is set between a side wall 322A of the lower part 322 and the inner surface of a side wall 252A of the lower region 252, and between the side wall 322B of the lower part 322 and the inner surface of the side wall 252B of the lower region 252. In FIG. 7, a state in which the respective centers of the fixed housing 20 and the movable housing 30 in the second direction y coincide is illustrated. The relative displacement in the second direction y of the movable housing 30 to the upper side or the lower side of FIG. 7 with respect to the fixed housing 20 from this state is allowed with the dimension of the second gap G2 as the limit. For example, when the second gap G2 is 1 mm, a floating range of +1 mm in the second direction y is given to the first connector 1.

Since the movable housing 30 and the fixed housing 20 are relatively displaceable in the first direction x and the second direction y, the movable housing 30 has a degree of freedom in position in the rotating direction as well within the xy plane with respect to the fixed housing 20. A floating range of a predetermined angle in the rotating direction within the xy plane is given to the first connector 1. Since the movable housing 30 and the fixed housing 20 are not restrained, a floating range suitable for sufficiently large gaps G1, G2 can be realized with a maximum elastic deformation amount of the first contact 10 as the limit.

### (First Contact)

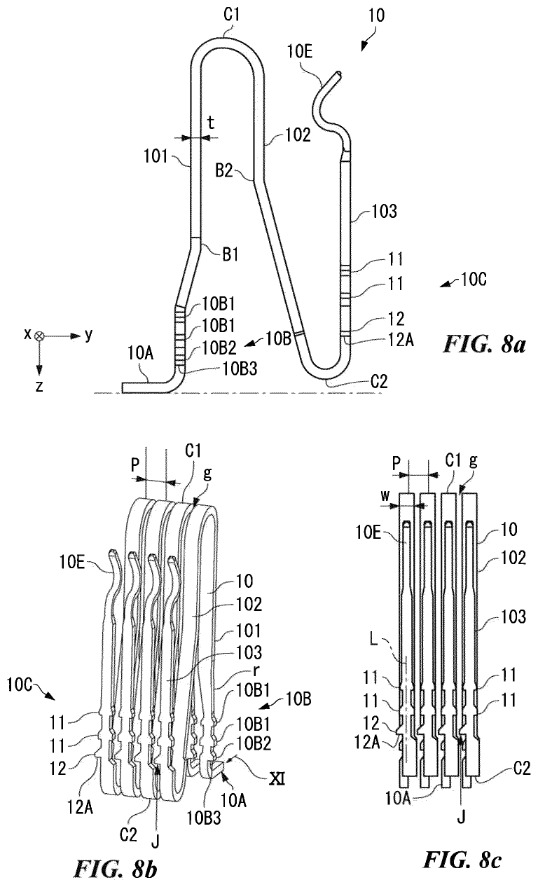

The configuration such as the shape of the first contact 10 and the function and the like of each part illustrated in FIGS. 8(a) to 8(c) will be described. FIGS. 8(a) to 8(c) show the first contact 10 in a state where load is not applied. The first contact 10 includes a joining portion 10A joined to the first mounting surface 61A by solder, a fixing retaining portion 10B retained in the fixed housing 20 by press-fitting, a movable retaining portion 10C retained in the movable housing 30 by press-fitting, and a connecting portion 10E that comes into contact with the second contact 40, and has a shape curved to be elastically deformable in the first direction x and the second direction y.

The joining portion 10A positioned parallel to the first mounting surface 61A and the fixing retaining portion 10B form an L-shape in side view. A first curved portion C1 and a second curved portion C2 are formed between the fixing retaining portion 10B and the movable retaining portion 10C. The first curved portion C1 serving as a top portion of the first contact 10 has a reverse U-shape in side view. The second curved portion C2 has a substantially V-shape in side view. The lower end of the second curved portion C2 is located above the joining portion 10A. The connecting portion 10E has a substantially C-shape in side view. The upper end of the connecting portion 10E is located below the upper end of the first curved portion C1. The first contact 10 is bent to a substantially N-shape as an overall schematic shape.

The first contact 10 is shaped by punching out a plate material made from a metal material such as copper alloy or the like to a linear elongate shape, and further performing bend processing. The floating range is set within a range of an elastic region of the first contact 10 for all directions of the first direction x, the second direction y, and the rotating direction within the xy plane. Thus, a material having satisfactory spring property is preferably used among the copper alloys for the material of the first contact 10 from the standpoint of increasing the floating range. The first contact 10 is given a constant plat thickness over a large portion in the length direction. A plate thickness t of the first contact 10 is determined within a range of, for example, 0.1 to 0.5 mm. The plate thickness of the connecting portion 10E is smaller than the plate thickness of other portions.

In order to stably shape the first contact 10, the width w of the first contact 10 is determined at least to a value greater than or equal to the plate thickness t, for example, within a range of 0.1 to 0.5 mm. The width w of the first contact 10 changes in the length direction of the first contact 10. For example, in the entire length from the joining portion 10A to the connecting portion 10E of the first contact 10, the widths of the joining portion 10A and the connecting portion 10E are the narrowest to facilitate bending and to enhance the following property to the first mounting surface 61A and the second contact 40. A region on the upper side than the movable retaining portion 10C of the first contact 10 is given a width narrower than the width of the movable retaining portion 10C. The relevant region is smoothly inserted to the retaining groove 310A of the movable housing 30 from below.

The first contacts 10 are positioned in a state where a gap g forms between adjacent first contacts 10 at a constant pitch P exceeding the maximum width w set to the first curved portion C1 and the second curved portion C2. The pitch P is, for example, 0.3 to 0.5 mm, and the first contacts 10 are densely positioned. The gap g is preferably greater than or equal to 0.15 mm. The first contact 10 are all positioned parallel to the xz plane. The first contact 10 of the first row R1 and the first contact 10 of the second row R2 are positioned line symmetrically with respect to an axis parallel to the mating direction z.

The first contact 10 includes a first zone 101, a second zone 102, and a third zone 103. The first zone 101 extends from the fixing retaining portion 10B to the first curved portion C1 toward a side (upper side) opposite to the first mounting surface 61A. The second zone 102 extends from the first curved portion C1 that is convexly curved upward toward the first mounting surface 61A, and continues to the movable retaining portion 10C by way of the second curved portion C2. The third zone 103 extends from the movable retaining portion 10C to the connecting portion 10E connected to the second contact 40 toward a side opposite to the first mounting surface 61A. In the first zone 101, a first bent portion B1 formed to a convex shape toward the second zone 102 is formed. In the second zone 102, a second bent portion B2 formed to a convex shape toward the first zone 101 is formed at a position distant from the first mounting surface 61A than the position of the first bent portion B1 in the mating direction z.

### (Configuration of Details of First Contact)

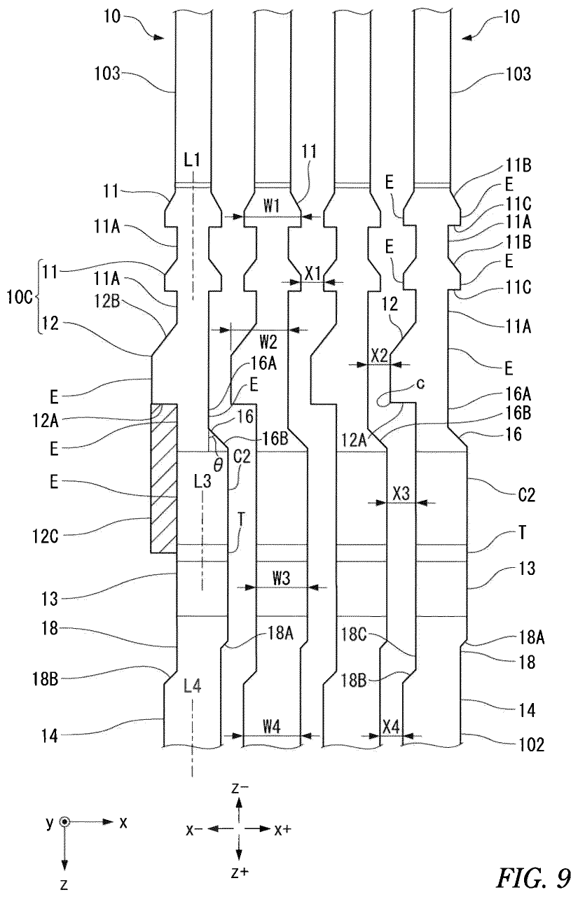

A configuration of the movable retaining portion 10C of the first contact 10 and a region adjacent to the movable retaining portion 10C will be described with reference to FIGS. 8(b), 8(c), 9 and 10. FIG. 9 shows a state in which a part of the second zone 102, the second curved portion C2, the movable retaining portion 10C, and a part of the third zone 103 of the first contact 10 are planarly developed including the second curved portion C2. Hereinafter, the configuration of the first contact 10 adopted from the standpoint of manufacturing property related to the press-fitting step of the first contact 10, and impedance matching in the transmission path configured by the circuit boards 61, 62 and the connectors 1, 4 will be described.

In particular, as illustrated in FIG. 9, the first contact 10 includes a press-fitting portion 11 press-fitted to the movable housing 30, a pushing protrusion 12 including a pushing surface 12A pushed by a jig (not illustrated) at the time of press-fitting of the press-fitting portion 11, a first wide width region 13 continuing to the back side z+ of the pushing protrusion 12 in the press-fitting direction z in which the press-fitting portion 11 is press-fitted, a transitioning portion 16 interposed between the pushing protrusion 12 and the first wide width region 13, a second wide width region 14, and a transitioning portion 18. The movable retaining portion 10C corresponds to the press-fitting portion 11 and the pushing protrusion 12. As illustrated in FIG. 8(a), the movable retaining portion 10C and the fixing retaining portion 10B are formed in parallel with respect to the press-fitting direction z in side view. The first wide width region 13 includes the second curved portion C2. The first wide width region 13 is curved to a convex shape toward the back side z+ in the press-fitting direction z.

The “press-fitting direction z” in the description related to the details of the first contact 10 corresponds to the mating direction z. Furthermore, the “width direction x” of the first contact 10 corresponds to the first direction x. Note that the second direction y corresponds to the thickness direction of the first contact 10. The back side z+ in the press-fitting direction z corresponds to the side (lower side) close to the first mounting surface 61A. The front side z− in the press-fitting direction z corresponds to the side (upper side) away from the first mounting surface 61A. The first contact 10 does not include twisted areas around the extending direction. Thus, the fracture surface of punching of the first contact 10 is directed only in the x direction, and is not directed in the y direction. The press-fitting portion 11, the pushing protrusion 12, the first wide width region 13, and the second wide width region 14 all have an edge E of both ends in the width direction x extending in parallel with respect to the press-fitting direction z.

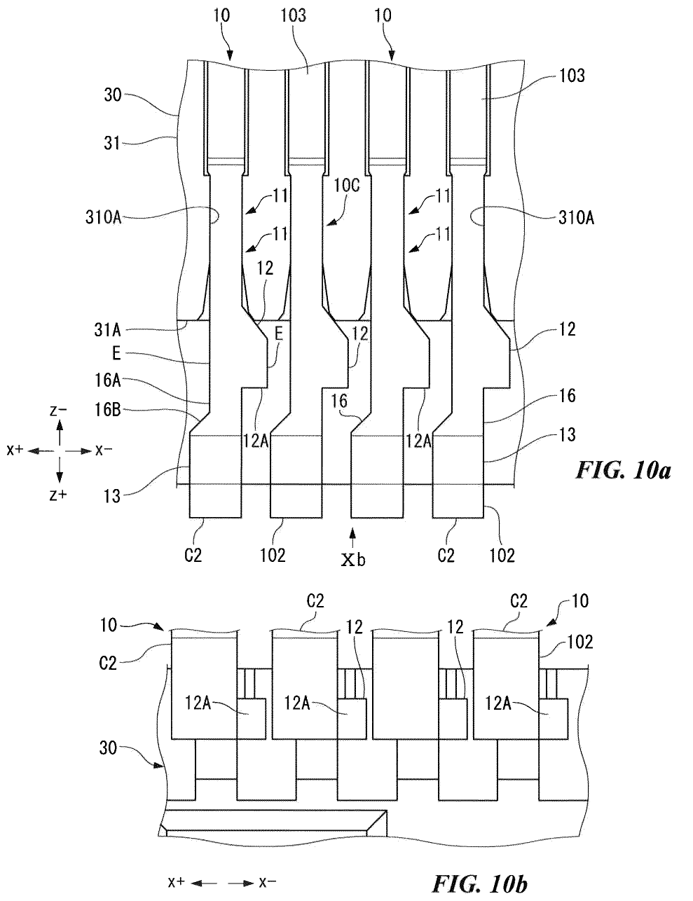

The press-fitting portion 11 is press-fitted to the retaining groove 310A (FIG. 10) of the movable housing 30 serving as the press-fitting target. The press-fitting portion 11 is formed over two stages with an interval in the press-fitting direction z. The first contact 10 extends from the press-fitting portion 11 toward the front side z- to the connecting portion 10E. Each of the two press-fitting portions 11 includes a press-fitting protrusion 111 projecting out to both sides in the width direction x with respect to a portion 11A having a narrow width adjacent to the press-fitting portion 11. The number of press-fitting portions 11 may be an appropriate number of greater than or equal to one. Each press-fitting protrusion 111 projects out in a trapezoidal shape in top view. Each press-fitting protrusion 111 has an inclined surface 11B on the front side z− in the press-fitting direction z, and has a perpendicular surface 11C on the back side z+. The inclined surface 11B is inclined with respect to the center line L1 in the width direction x of the press-fitting portion 11, and the perpendicular surface 11C is formed perpendicular to the center line L1.

The pushing protrusion 12 projects out to one side x− in the width direction x on the back side z+ than the press-fitting portion 11 in the press-fitting direction z. The pushing protrusion 12 also serves as a protrusion for locating the press-fitting portion 11. The pushing protrusion 12 projects out beyond the position of the press-fitting portion 11 to one side x− in the width direction x. That is, the dimension in which the pushing protrusion 12 projects out in the width direction x from the narrow width portion 11A is larger than the dimension in which the press-fitting portion 11 projects out in the width direction x from the narrow width portion 11A. The pushing protrusion 12 projects out only to one side in the width direction x with respect to the portion 11A having a narrow width adjacent to the press-fitting portion 11. The edge E on the side opposite to the pushing protrusion 12 in the width direction x extends on the same straight line as the edge of the portion 11A having a narrow width. At the position of the pushing protrusion 12 as well, a required clearance X2 can be between the respective pushing protrusions 12 of the first contacts 10 positioned side by side in the width direction x, from the position of the edge E on the side opposite to the pushing protrusion 12 to the position not overlapping the pushing protrusion 12 of the first contact 10 adjacent in the width direction x as the limit.

The clearance X2 is set to, for example, greater than or equal to 60% of the plate thickness t of the pushing protrusion 12 to avoid damage of an element (corresponds to punch, die) used in the punching step (stamping step) while preventing the first contacts 10 from coming into contact with each other. This is the same for clearances X1, X3, and X4. The array state of the first contacts 10 when punched out from the sheet material at the time of stamping processing corresponds to the array state of the first contacts 10 when provided in the first connector 1. In order to stably produce the first contact 10, for example, when the plate thickness t of the first contact 10 is 0.2 mm, a clearance of greater than or equal to 0.12 mm corresponding to 60% of the plate thickness t is required between the first contacts 10. The clearance X2 may be the same as the clearance X1 between the press-fitting portions 11 of the first contacts 10 positioned side by side in the width direction z. The width W2 of the pushing protrusion 12 is set in view of the width of the pitch P, the clearance X2, and the width necessary for the thin portion 11A of the press-fitting portion 11. For example, when the pitch P is 0.5 mm and the clearance X2 of at least 0.12 mm is required, the width W2 needs to be suppressed to less than or equal to 0.38 mm.

Similarly to the press-fitting portion 11, the pushing protrusion 12 is also formed to a trapezoidal shape. An inclined surface 12B is formed on the front side z− of the pushing protrusion 12. A pushing surface 12A to be pushed by the press-fitting jig (not illustrated) is formed perpendicular to the center line L1 on the back side z+ of the pushing protrusion 12. In FIG. 10(a), the press-fitting portion 11, the pushing protrusion 12, and the first wide width region 13 are illustrated, together with the retaining groove 310A of the movable housing 30. In FIG. 10(b), the pushing surface 12A and the second curved portion C2 are illustrated.

The projection amount of the pushing protrusion 12 is larger than the projection amount of the press-fitting protrusion 111, and thus the pushing surface 12A is large in the width direction x as compared with the perpendicular surface 11C of the press-fitting protrusion 111. Thus, in the densely positioned first contacts 10, the press-fitting jig may not be positioned on the perpendicular plane 11C but the press-fitting jig can be positioned on the pushing surface 12A formed on the pushing protrusion 12. For example, when the pitch P of the first contacts 10 is 0.5 mm, a width of greater than or equal to 0.1 mm, for example, can be ensured in the pushing surface 12A, and thus the pushing surface 12A can be stably pushed with the press-fitting jig.

In order to match impedances while avoiding the region 13 on the back side z+ than the pushing surface 12A from interfering with the press-fitting jig, a sufficient cross sectional area is to be ensured in the region 13 to avoid increase in impedance. Since the plate thickness of the first contact 10 is constant except for the connecting portion 10E, ensuring sufficient width in the region 13 contributes to impedance matching. Thus, the first wide width region 13 on the back side z+ than the pushing surface 12A is shifted to the side x+ opposite to one side x− in the width direction x in which the pushing protrusion 12 projects out with respect to the press-fitting portion 11.

The press-fitting jig is positioned on the back side (z+) of the pushing surface 12A in the press-fitting direction z, and pushes the pushing surface 12A toward the front side z− in the press-fitting direction z, as indicated with an arrow J in FIGS. 8(b) and 8(c). The pushing surface 12A is opened to the back side z+ in the press-fitting direction (z) to arrange the press-fitting jig. That is, the region 12C (FIG. 9) projected toward the back side z+ from the pushing surface 12A does not include the edge E of the transitioning portion 16 continuing to the back side z+ from the pushing surface 12A nor the edge E of the first wide width region 13. The edge E of the transitioning portion 16 and the edge E of the first wide width region 13 both extend to the back side z+ perpendicularly to the pushing surface 12A.

Since the pushing surface 12A is opened to the back side z+ in the press-fitting direction (z), the press-fitting jig can be positioned without interfering with the transitioning portion 16 and the first wide width region 13. Note that a lowermost end of the first contact 10 in the projection region 12C is the top portion T of the second curved portion C2, and thus when the press-fitting jig is inserted from the back side z+ side in the press-fitting direction z, it may be sufficient to be opened from the pushing surface 12A to the top portion T of the second curved portion C2.

As described above, the first wide width region 13 is shifted to the side x+ opposite of one side x− in which the pushing protrusion 12 projects out with respect to the press-fitting portion 11. That is, the center line L3 of the first wide width region 13 is shifted to the x+ side of the width direction x with respect to the center line L1 in the press-fitting portion 11. Thus, the pushing surface 12A is opened to the back side z+ of the press-fitting direction z, and the first wide width region 13 has a width W3 wider than the width W1 of the press-fitting portion 11. The first wide width region 13 may be given a width wide as possible while setting a necessary clearance X3 between the first wide width regions 13 positioned side by side in the width direction x, with a distance from the position of the edge E perpendicular to the pushing surface 12A to the position not overlapping with the projection region 12C of the pushing surface 12A of the first contact 10 adjacent on the x+ side in the width direction x as the limit. The width W3 of the first wide width region 13 may be the same as the width W2 at the position of the pushing protrusion 12.

According to the first wide width region 13 given width W3, the ratio of the width with respect to the plate thickness can be sufficiently ensured in order to stably perform the processing of punching and bending of the first contact 10. Twist is less likely to occur at the time of processing the larger the ratio of the width with respect to the plate thickness. The width W3 of the first wide width region 13 is preferably constant from the standpoint of stability of processing and impedance matching.

The first wide width region 13 has the second curved portion C2 connected to the pushing protrusion 12 by way of the transitioning portion 16 at the position exceeding the connecting portion 10E side. In the range where the bending process is performed, it is preferable to avoid changing the width or shifting the position in the width direction. In the present embodiment, the range where the bending process of the second curved portion C2 is performed falls within the first wide width region 13. In the relevant range, the transitioning portions 16, 18 where the width and the position are switched do not exist, and thus the bending process of the second curved portion C2 is stably performed.

Similarly to the width at the position of the pushing surface 12A, the transitioning portion 16 gradually widens to the x+ side in the width direction x by an inclined surface 16B from a portion 16A having a narrow width to the first wide width region 13, and continues to the first wide width region 13. Since it is a disadvantage from the standpoint of impedance matching if the width is narrow compared with the pushing protrusion 12 and the first wide width region 13, the length of the portion 16A in the press-fitting direction z is preferably as short as possible. However, the width of the transitioning portion 16 preferably gradually increases toward the back side z+ due to the concentration of stress at the time of bending process and influence on impedance matching caused by the sudden change in width. Thus, an angle θ formed by the inclined surface 16B with respect to the portion 16A is, for example, set to 45° with respect to the center line L1. A corner c of the pushing surface 12A of the pushing protrusion 12 and the transitioning portion 16 of the first contact 10 adjacent on the x− side are positioned separated in the press-fitting direction z at an extent necessary for avoiding the contact of the first contacts 10.

The first contact 10 preferably includes a second wide width region 14 continuing to the side opposite to the pushing protrusion 12 side of the first wide width region 13. The second wide width region 14 belongs to the first zone 101 and the second zone 102. The second wide width region 14 is shifted to the x− side which is a direction in which the pushing protrusion 12 projects out with respect to the first wide width region 13.

Since the press-fitting jig does not interfere with the second wide width region 14, the width of the second wide width region 14 can be widened to the pushing surface 12A side. Thus, the width of the second wide width region 14 is not only wider than the press-fitting portion 11 but is also wider than the first wide width region 13. A sufficient width W4 is given to the second wide width region 14 to reduce impedance while ensuring a necessary clearance X4 between the second wide width regions 14 positioned side by side in the width direction x. The width W4 and the width W2 of the pushing protrusion 12 described above correspond to the maximum width in the first contact 10.

The second wide width region 14 is given a constant width W4 up to the position beyond the first curved portion C1 on the joining portion 10A side in the second zone 102, and the clearance X4 is also constant. The second wide width region 14 has a widest width and has a long extending length in the first contact 10, and thus greatly contributes to improving the impedance matching. The second wide width region 14 goes beyond the first curved portion C1 to the joining portion 10A side, and continues to the fixing retaining portion 10B through the region r where the width gradually decreases.

The center line L4 of the second wide width region 14 coincides with the center line L1 if extended to the press-fitting portion 11, and also coincides with the center line (not illustrated) in the width direction x of the joining portion 10A if further extended. Furthermore, the center line L4 of the second wide width region 14 coincides with the center line (not illustrated) in the width direction x of the joining portion 10A if extended to the joining portion 10A.

The position of the first contact 10 in the width direction x returns to the same position as the press-fitting portion 11 in the second wide width region 14 through the pushing protrusion 12 projecting out to one side in the width direction x and the first wide width region 13 shifted with respect to the press-fitting portion 11 from the press-fitting portion 11. That is, the press-fitting portion 11, the pushing protrusion 12, the first wide width region 13, and the second wide width region 14 are shifted to one side x− and the other side x+ in the width direction x to be formed to a zigzag shape as a whole. The dimension in the width direction x can be suppressed as a whole from one end to the other end in the extending direction of the first contact 10 by returning from the first wide width region 13 shifted to the x+ side with respect to the press-fitting portion 11 to the same position as the press-fitting portion 11 in the width direction x due to the existence of the second wide width region 14. Thus, it can contribute to downsizing of the connector 1 as compared with a case of not returning.

The first wide width region 13 is connected to the second wide width region 14 through the transitioning portion 18 at a position beyond the second curved portion C2 on the first curved portion C1 side. The transitioning portion 18 has a narrow width between the first wide width region 13 and the second wide width region 14, and includes a short part 18C in the press-fitting direction z. This transitioning portion 18 is also preferably short as possible from the standpoint of impedance matching. The inclined surface 18A on the front side z− of the transitioning portion 18 and the inclined surface 18B on the back side z+ of the transitioning portion 18 adjacent on the x+ side are positioned separated in the press-fitting direction z at an extent necessary for avoiding contact between the first contacts 10.

As opposed to the present embodiment, it is permitted that the position of the first contact 10 in the width direction x does not return to the position of the press-fitting portion 11 by the transitioning portion 18 and the second wide width region 14, and the first wide width region 13 extends toward the joining portion 10A in a state of being shifted with respect to the press-fitting portion 11. In this case as well, as wide as possible width of the first wide width region 13 is preferably ensured from the position corresponding to the transitioning portion 18 to the position beyond the first curved portion C1. Furthermore, since both ends of the first contact 10, that is, the connecting portion 10E and the joining portion 10A are shifted in the width direction x, the terminal of the first circuit board 61 and the mating contact 40 are positioned in accordance with the positions of the connecting portion 10E and the joining portion 10A.

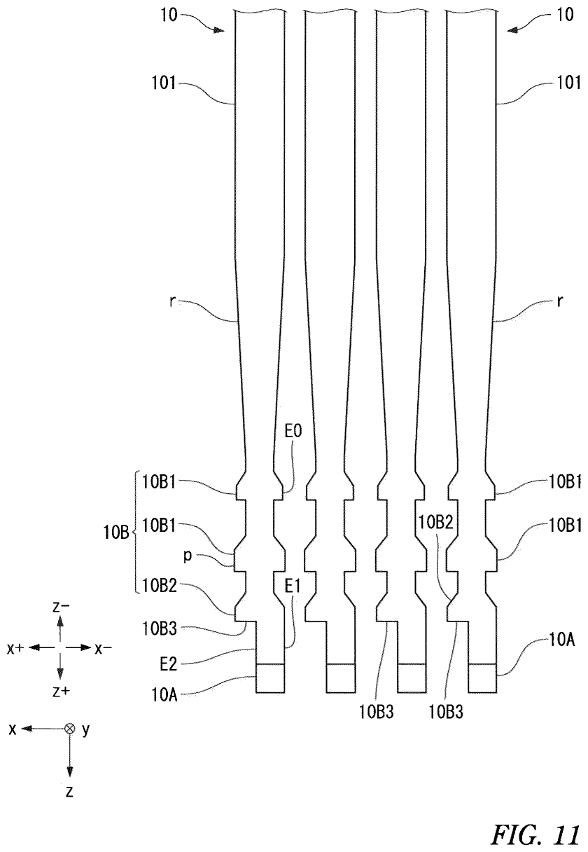

As illustrated in FIG. 11, the fixing retaining portion 10B of the fixed housing 20 includes a press-fitting portion 10B1 and a pushing protrusion 10B2. The press-fitting portion 10B1 is configured similarly to the press-fitting portion 11 of the movable retaining portion 10C, and is press-fitted to the fixed housing 20 in the same press-fitting direction z. The pushing protrusion 10B2 is located on the back side z+ than the press-fitting portion 10B1 in the press-fitting direction z. This pushing protrusion 10B2 is formed with a pushing surface 10B3 having a width same as the pushing surface 12A of the pushing protrusion 12 of the movable retaining portion 10C. The pushing surface 10B3 is opened to the back side z+ of the press-fitting direction z.

The back side z+ of the pushing protrusion 10B2 of the fixing retaining portion 10B is continued to the joining portion 10A. As described above, in relation to the width of the joining portion 10A being narrow to enhance the following property to the first mounting surface 61A, the projection amount of the pushing protrusion 10B2 to one side x+ in the width direction x is the same as the projection amount of the press-fitting protrusion p of the press-fitting portion 10B1 to the same x+ side. That is, the projection amount of the pushing protrusion 10B2 is smaller than the projection amount of the pushing protrusion 12 of the movable retaining portion 10C. The edge E1 on the x− side of the pushing protrusion 10B2 is on the extension line of the edge E0 of the press-fitting protrusion p. The joining portion 10A is formed by the edge E1 and the edge E2 perpendicular to the pushing surface 10B3. The width of the joining portion 10A may be, for example, the same as the width of the portion having a narrow width of the press-fitting portion 10B1.

If the width of the joining portion 10A does not need to be narrowed, the fixing retaining portion 10B. Furthermore, the retaining portion 40B of the second contact 40 to be described later may include the pushing protrusion 12, the first wide width portion 13, and the like similarly to the movable retaining portion 10C.

### (Ground Contact Connecting Element)

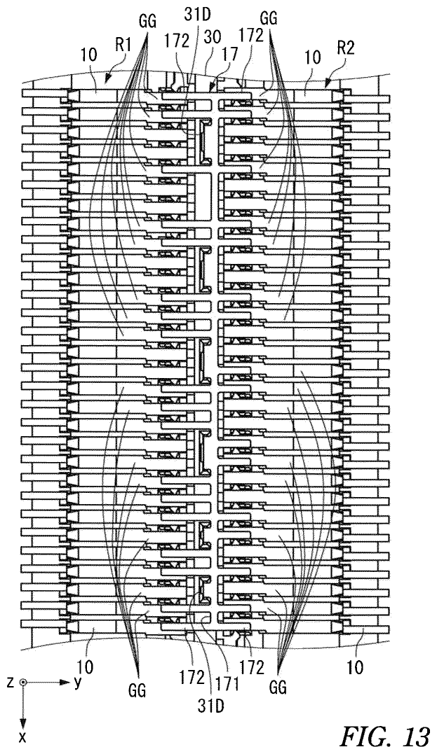

One part of the first contact 10 configuring the first row R1 corresponds to a signal potential of an electronic circuit including the first circuit board 61 and the second circuit board 62, and the remaining part corresponds to a ground potential in the electric circuit. Similarly, one part of the first contact 10 configuring the second row R2 corresponds to a signal potential in the electronic circuit, and the remaining part corresponds to a ground potential in the electronic circuit. The allocation for signal/ground with respect to the first contact 10 is appropriately designed. In the allocation for signal/ground, various patterns exist depending on the product. As illustrated in FIGS. 12 and 13, the ground contact connecting element 17 comes into contact with only a ground contact group GG including a plurality of first contacts 10 allocated for ground among all the first contacts 10. The first contacts 10 to which the ground contact connecting element 17 comes into contact all have the same potential. In FIG. 13, the reference numerals of GG are illustrated divided into four parts for the sake of convenience of illustration. The ground contact group GG corresponds to the first contact 10 of one group corresponding to the ground potential, and the ground contact group GG corresponds to the first contact 10 of one part of the first row R1 and the first contact 10 of one part of the second row R2, for the ground contact connecting element 17 as a whole.

The ground contact connecting element 17 includes a supporting portion 171 provided at the lower end 31A of the movable housing 30 and extending in the first direction x, and a plurality of contact beams 172 that come into contact with the second curved portions C2 of each of the first contacts 10 configuring the ground contact group GG. The contact beam 172 is positioned between the lower end 31A and the first mounting surface 61A, and comes into contact with the second curved portion C2 of the first contact 10 adjacent to the lower end 31A from the first mounting surface 61A side.

The second curved portion C2 of the first contact 10 is located in the vicinity of the movable retaining portion 10C retained by the movable housing 30, and thus displaces following the movable housing 30. Thus, even if the movable housing 30 is displaced with respect to the fixed housing 20 and the housing 50 of the second connector 4 while elastically deforming the first curved portion C1 of the first contact 10 at the time of mating of the first connector 1 and the second connector 4, the distance between the second curved portion C2 and the movable housing 30 barely changes. As a result, even if the contact beam 172 is in contact with the second curved portion C2, the behavior in which the movable housing 30 displaces within the floating range with respect to the fixed housing 20 is not affected.

The supporting portion 171 is provided with a plurality of retaining portions 171A to be press-fitted to each ground retaining groove 31D of the movable housing 30. The press-fitting protrusion 171B is formed on both sides of the retaining portion 171A in the first direction x. The contact beam 172 projects out in the second direction y toward the ground contact 10 of the first row R1 or the ground contact 10 of the second row R2 perpendicularly from the supporting portion 171. In the present embodiment, the length of the contact beam 172 extending toward the first row R1 side from the supporting portion 171 and the length of the contact beam 172 extending toward the second row R2 side from the supporting portion 171 are different, but they may be the same. The width (dimension in the first direction x) of the contact beam 172 is narrower than the width (dimension in the first direction x) at the area of coming into contact with the contact beam 172 of the first contact 10. The width of the contact beam 172 may be the same as the joining portion 10A and the connecting portion 10E of the first contact 10.

The ground contact connecting element 17 can be shaped by performing processing of punching and bending on the metal plate material such as copper alloy. The retaining portion 171A is bent perpendicularly on one side of the supporting portion 171 in the width direction (second direction y). The retaining portion 171A can be formed at an arbitrary part in the first direction x excluding the area (e.g., x4 in FIG. 12) where the contact beam 172 is formed on both sides of the supporting portion 171 in the width direction.

The ground contact connecting element 17 can respond to various products by customizing the position of the contact beam 172 and the retaining portion 171A according to the pattern of allocation for signal/ground. In order to respond to the change in position of the retaining portion 171A by customizing, the movable housing 30 in which the position of the ground retaining groove 31D is different is preferably producible by having the portion corresponding to the ground retaining groove 31D in the shaping die of the movable housing 30 as a nest.

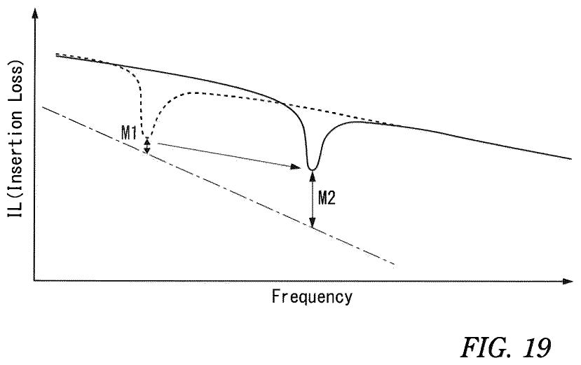

The SI (Signal Intensity) performance can be enhanced, as illustrated in the analysis result of frequency characteristics of insertion loss (IL) in FIG. 19, for example, by using the ground contact connecting element 17. The broken line in FIG. 19 indicates the insertion loss frequency characteristics when the first connector 1 does not include the ground contact connecting element 17, and the solid line indicates the insertion loss frequency characteristics when the first connector includes the ground contact connecting element 17. The one dot chain line schematically shows the required specification. From FIG. 19, it can be seen that the peak of the resonance frequency shifts to the high frequency side by using the ground contact connecting element 17. As a result of the design margin on the required specification enlarging from M1 to M2 accompanying therewith, the SI performance enhances.

### [Second Connector]

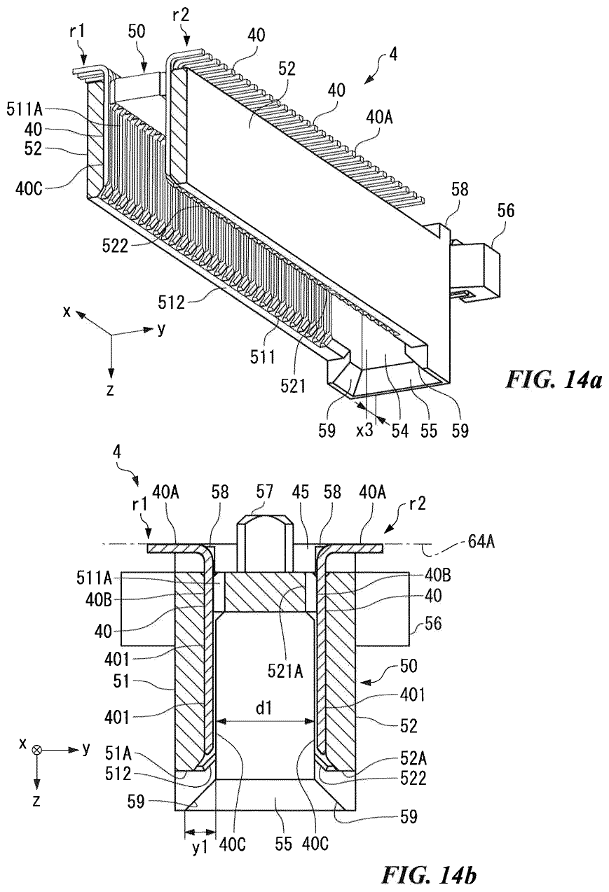

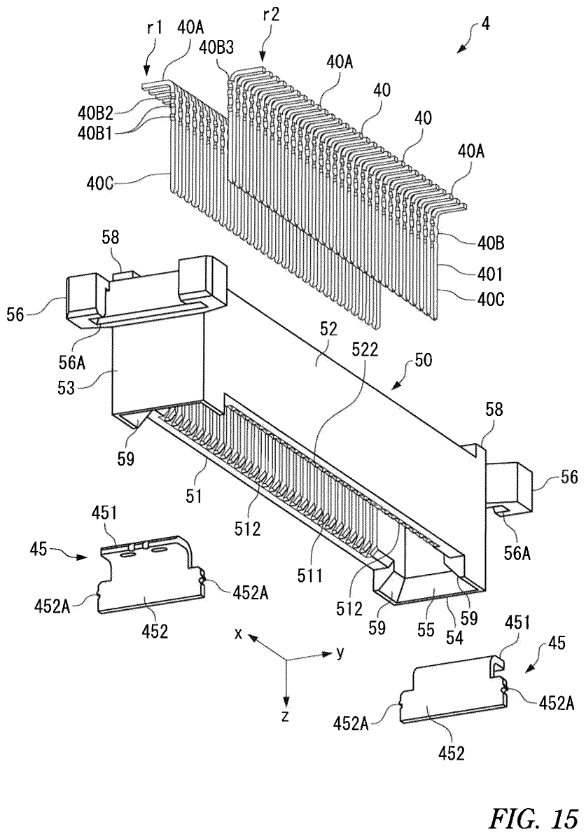

A more specific configuration of the second connector 4 will be described with reference to FIGS. 14(a), 14(b) and 15. The second connector 4 includes a plurality of second contacts 40, a housing 50 for retaining the same, and a joining element 45, and is mated with the movable housing 30. The second contact 40 of the first row r1 and the second contact 40 of the second row r2 are positioned at a constant pitch P in the first direction x similarly to the first contact 10, and are adjacent in the second direction y.

The second contact 40 is shaped by punching out a plate raw material made from a metal material such as copper alloy or the like to a linear elongate shape, and further performing bend processing. The second contact 40 includes a joining portion 40A joined to the second circuit board 62, a retaining portion 40B retained by the housing 50, and a connecting portion 40C electrically connected to the first contact 10.

The second contact 40 of the present embodiment has a zone 401 extending perpendicular to the joining portion 40A, and is formed to an L-shape as a whole. The zone 401 includes the retaining portion 40B and the connecting portion 40C. The retaining portion 40B includes a press-fitting portion 40B1 and a pushing protrusion 40B2 similar to the press-fitting portion 10B1 and the pushing protrusion 10B2 of the fixing retaining portion 10B, and is formed in the vicinity of the joining portion 40A in the zone 401. A region on the lower side than the retaining portion 40B in the zone 401 corresponds to the connecting portion 40C. As illustrated in FIG. 1(b), the connecting portion 10E of the first contact 10 of the first row R1 and the connecting portion 10E of the first contact 10 of the second row R2 are inserted between the connecting portion 40C of the first row r1 and the connecting portion 40C of the second row r2.

The housing 50 surrounds the second contacts 40 of the first row r1 and the second row r2 from four sides, and includes walls 51 to 54 positioned on the second mounting surface 62A, a joining element retaining portion 56 for retaining the joining element 45, two bosses 57 (FIG. 1(a)) for locating inserted to a hole (not illustrated) of the second circuit board 62, and a leg portion 58 positioned on the second mounting surface 62A.

The side wall 51 and the side wall 52 extend in the first direction x at a length corresponding to the length of the rows r1, r2, and face each other in the second direction y. On the inner side of the side wall 51, the grooves 511 in which the second contacts 40 of the first row r1 are respectively positioned are formed along the mating direction z. The groove 511 includes a retaining groove 511A to which the second contact 40 is press-fitted. On the inner side of the side wall 52 as well, the grooves 521 in which the second contacts 40 of the second row r2 are respectively positioned and includes a retaining groove 521A are formed along the mating direction z.

On the inner side at the lower end of the side wall 51, a guide inclined surface 512 is formed to relatively locate the movable housing 30 of the first connector 1 and the housing 50 in the second direction y. On the inner side at the lower end of the side wall 52 as well, a similar guide inclined surface 522 is formed. The guide inclined surfaces 512, 522 are symmetrically formed in the second direction y.

When the second contact 40 is inserted to each groove 511, 521 of the housing 50 from the connecting portion 40C side, and press-fitted to the retaining groove 511A, 521A, the distal end of the connecting portion 40C is positioned adjacent to the guide inclined surfaces 512, 522, as illustrated in FIG. 14(b). The joining portion 40A is positioned on the outer side of the grooves 511, 521. The joining portion 40A is located slightly above the position of the leg portion 58.

The distance d1 in the second direction y between the connecting portion 40C of the second contact 40 of the first row r1 and the connecting portion 40C of the second contact 40 of the second row r2 is smaller than the distance d2 (FIG. 2(b)) in the second direction y between the vertex of the connecting portion 10E of the first contact 10 of the first row R1 and the vertex of the connecting portion 10E of the first contact 10 of the second row R2. When the first connector 1 and the second connector 4 are mated as illustrated in FIG. 1(b), the connecting portion 10E of the first contact 10 of the first row R1 comes into contact with the connecting portion 40C of the second contact 40 at the vertex while being pressed between the second contact 40 of the first row r1 and the movable housing 30. This is the same for the connecting portion 10E of the first contact 10 of the second row R2. The connecting portions 40C of the second contact 40 can stably bring into contact the connecting portion 40C and the connecting portion 10E as they are linearly formed in the mating direction z even if the positions of the first contact 10 and the second contact 40 in the mating direction z are shifted.

The walls 53, 54 are provided at both ends in the first direction x of the side walls 51, 52, and face each other in the first direction x. The height of the walls 53, 54 from the second mounting surface 62A is higher than the height of the side walls 51, 52 from the second mounting surface 62A.

The first guide inclined surface 55 inclined with respect to the yz plane is formed at both ends in the first direction x of the walls 51 to 54. The second guide inclined surface 59 inclined with respect to the xz plane is formed at four corners of the walls 51 to 54. The guide inclined surfaces 55, 59 are positioned below the lower ends 51A, 52A of the side walls 51, 52. The first guide inclined surface 55 is symmetrically formed in the first direction x. The second guide inclined surface 59 is symmetrically formed in the second direction y.

The first guide inclined surface 55 comes into contact with the inclined surface 321A of the guide protrusion 321 of the movable housing 30 before the guide inclined surfaces 512, 522 of the side walls 51, 52 come into contact with the guide inclined surface 31C of the movable housing 30, and guides the movable housing 30 in the first direction x following the position of the housing 50. At the same time, the second guide inclined surface 59 comes into contact with the inclined surface 321B of the guide protrusion 321 of the movable housing 30 before the guide inclined surfaces 512, 522 of the side walls 51, 52 come into contact with the guide inclined surface 31C of the movable housing 30, and guides the movable housing 30 in the second direction y following the position of the housing 50. The first guide inclined surface 55 is inclined with respect to the yz plane. The second guide inclined surface 59 is inclined with respect to the xz plane.

A guide range x3 (FIG. 14(a)) same as that of the inclined surface 321A of the guide protrusion 321 of the movable housing 30 is set in the first guide inclined surface 55. The guide range x3 is preferably larger than the dimension of the first gap G1. A guide range y1 (FIG. 14(b)) same as that of the inclined surface 321B of the guide protrusion 321 of the movable housing 30 is set in the second guide inclined surface 59. The guide range y1 is preferably larger than the dimension of the second gap G2.

The joining element 45 includes a joining portion 451 to be joined to the second circuit board 62 and a press-fitting portion 452 having protrusions 452A on both sides. The joining element retaining portion 56 is provided on the outer side of the walls 53, 54. The joining element retaining portion 56 is formed with a retaining groove 56A to which the joining element 45 is press-fitted from below.

### [Effect by First Contact of the Present Embodiment]

In the first contact 10 of the present embodiment, the pushing protrusion 12 in which the projection amount in the width direction x is larger than the press-fitting portion 11 is formed, and the first wide width region 13 is shifted in the width direction x in a direction opposite to the direction in which the pushing protrusion 12 projects out with respect to the press-fitting portion 11. According to such a configuration, even in a case where the first contacts 10 are positioned densely, the dimension in the width direction x necessary for the pushing surface 12A pushed by the jig can be ensured, and thus the manufacturing property of the first contact 10 can be satisfied. In addition, sufficient width W3 can be given to the first wide width region 13 while ensuring the clearance X3, and hence satisfactory impedance matching of the transmission path including the first contact 10 can be realized. The configuration of the first contact 10, of course, does not influence the floating range and the floating performance of the connector assembly 100.

### [Assembly of Connector Assembly]

Hereinafter, a procedure for assembling the connector assembly 100 will be described. The effects obtained by the present embodiment will be referred to. First, an example of a procedure for assembling the first connector 1 will be described. The housing joining element 15 is press-fitted from above to each of a pair of grooves 261 provided in each expansion wall 25 on both sides of the fixed housing 20 (FIG. 2(a)). Furthermore, the movable housing 30 is positioned on the inner side of the fixed housing 20 from below (FIG. 2(b), FIG. 6).

Thereafter, a plurality of first contacts 10 can be attached from below to the fixed housing 20 and the movable housing 30 while using a jig (not illustrated). For example, the fixed housing 20 and the movable housing 30 are supported at a predetermined position by a first jig, and the first contacts 10 of the first row R1 and the second row R2 are pushed upward by a third jig for press-fitting in contact with the pushing surface 10B3 and a third jig for press-fitting in contact with the pushing surface 12A while aligning the first contacts 10 in the first row R1 and the second row R2 by the second jig.

Then, the first contacts 10 of each row R1, R2 are inserted between the fixed housing 20 and the movable housing 30 from the first curved portion C1 and the connecting portion 10E side. As illustrated in FIG. 2(b), the fixing retaining portion 10B of the first contact 10 of the first row R1 is press-fitted to the retaining groove 211 of the fixed housing 20, and the movable retaining portion 10C of the first contact 10 of the first row R1 is press-fitted to the retaining groove 310A on the first row R1 side of the movable housing 30. At the same time, the fixing retaining portion 10B of the first contact 10 of the second row R2 is press-fitted to the retaining groove 221 of the fixed housing 20, and the movable retaining portion 10C of the first contact 10 of the second row R2 is press-fitted to the retaining groove 310A on the second row R2 side of the movable housing 30.

When the fixing retaining portion 10B and the movable retaining portion 10C are press-fitted, the movable housing 30 is supported by the second curved portion C2 of the first contact 10 of the first row R1 and the second curved portion C2 of the first contact 10 of the second row R2. At this time, the lower end 31A of the movable housing 30 is located above the leg portion 28 of the fixed housing 20. The second curved portion C2 is located below the lower end 31A of the movable housing 30 and is located above the leg portion 28. The joining portion 10A of the contact 10 is located on the slightly lower side of the leg portion 28 of the fixed housing 20.

After attachment of the first contact 10, the retaining portion 171A is press-fitted to the ground retaining groove 31D to attach the ground contact connecting element 17 to the movable housing 30. When the retaining portion 171A is press-fitted to the ground retaining groove 31D up to a predetermined depth, each contact beam 172 is bent in the plate thickness direction, and pressed in the mating direction z with respect to the second curved portion C2 of the first contact 10 for ground. Thus, even if the position of the second curved portion C2 of each first contact 10 is varied in the mating direction z, the contact beam 172 can be stably brought into contact with the contact group GG. The SI performance thus can be stabilized by having the contacts 10 for ground at the same potential by an element 17 including the contact beam 172 stably brought into contact with the first contact 10.

The assembly of the first connector 1 is thereby completed (FIGS. 2(a), 2(b)). The movable housing 30 is supported in a state having degree of freedom in position over the floating range in the first direction x, the second direction y, and the rotating direction within the xy plane by the elastic deformation of the first contact 10 of the first row R1 and the first contact 10 of the second row R2.

As illustrated in FIG. 1(b), when the first connector 1 is positioned and mounted on the first circuit board 61, the two bosses 27 of the fixed housing 20 are inserted to the holes (not illustrated) of the first circuit board 61, respectively, and the leg portion 28 is brought into contact with the first mounting surface 61A. In this state, the joining portion 10A of each first contact 10 is joined to a terminal portion (not illustrated) formed in the first mounting surface 61A by solder, and the joining portion 151 of the housing joining element 15 is joined to the first mounting surface 61A by solder. The joining strength of the first circuit board 61 and the first connector 1 is enhanced by using the housing joining element 15.

When the fixed housing 20 is fixed to the first circuit board 61 by joining the first contact 10 and the housing joining element 15, as illustrated in FIG. 6, the lower part 322 of the movable housing 30 positioned between the opposing portion 251 of the fixed housing 20 and the first circuit board 61, and thus the movable housing 30, the fixed housing 20, and the first circuit board 61 are assembled to each other.

On the other hand, when assembling the second connector 4 (FIGS. 14 and 15), for example, the second contacts 40 are inserted to the grooves 511, 521 of the housing 50 from above while being aligned in the first row r1 and the second row r2 using a jig (not illustrated), and the pushing surface 40B3 is pushed to press-fit the second contacts 40 into the retaining grooves 511A, 521A. Furthermore, the joining element 45 is press-fitted to the joining element retaining portion 56. As described above, the assembly of the second connector 4 is completed.

When arranging and mounting the second connector 1 on the second circuit board 62, the boss 57 of the housing 50 is inserted to a hole (not illustrated) of the second circuit board 62, and the leg portion 58 is brought into contact with the second mounting surface 62A. In this state, the joining portion 40A of each second contact 40 is joined to the second mounting surface 62A by solder, and the joining portion 451 of the joining element 45 is joined to the second mounting surface 62A by solder.

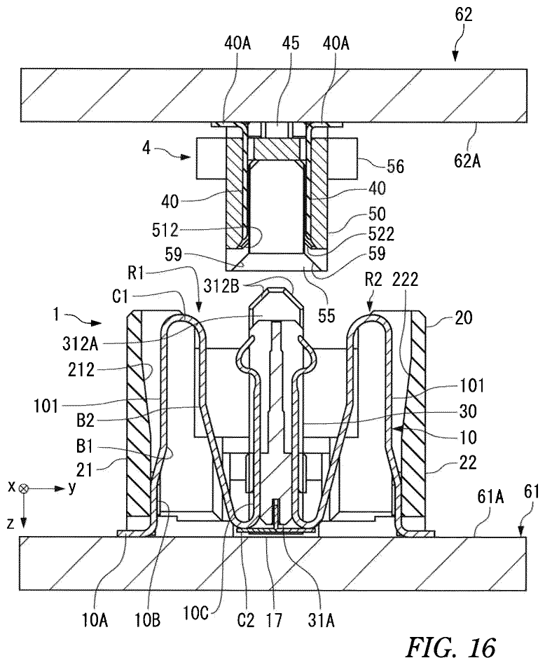

When assembling a structure including the first circuit board 61 and the first connector 1 and a structure including the second circuit board 62 and the second connector 4, the respective positions in the second direction y of the first connector 1 and the second connector 4 may not necessarily coincide, as illustrated in FIG. 16, due to the accumulated tolerance of tolerances and the like of dimensional shape, processing and assembly of the elements. However, even if each position of the first connector 1 and the second connector 4 is shifted in at least one of the first direction x and the second direction y, the first connector 1 and the second connector 4 are mated to obtain the connector assembly 100 based on the configuration of the first connector 1, and the first circuit board 61 and the second circuit board 62 can be assembled.

In a state in which the movable housing 30, the fixed housing 20, and the first circuit board 61 are assembled, the movable housing 30 is supported by the fixed housing 20 through the first contact 10. That is, the movable housing 30 is supported in a displaceable manner by elastically deforming the first contact 10 in the first direction x and the second direction y. At this time, as a direct relationship of the movable housing 30 and the fixed housing 20, the lower part 322 of the movable housing 30 and the opposing portion 251 of the fixed housing 20 face each other in the mating direction z, and the relative displacement of the movable housing 30 including the lower part 322 and the fixed housing 20 including the opposing portion 251 in the first direction x and the second direction y can be performed within a range of the floating range corresponding to the gaps G1, G2 set between the movable housing 30 and the fixed housing 20. Here, since the movable housing 30 and the fixed housing 20 are assembled by arranging the lower part 322 between the opposing portion 251 and the first circuit board 61, the movable housing 30 and the fixed housing 20 are not restrained by metal fitting or the like for assembly. The relative displacement between the movable housing 30 and the fixed housing 20 are thus not inhibited by the metal fitting, and hence sufficient floating range can be ensured over the entire gaps G1, G2. Thus, according to the present embodiment, for example, the first connector 1 capable of enlarging the floating range to a scale of greater than or equal to +1 mm and a connector assembly 100 can be provided.

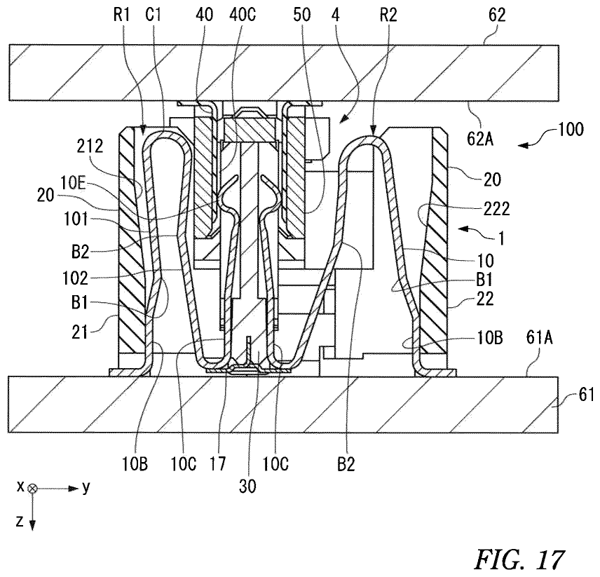

For example, when mating the first connector 1 and the second connector 4 in which positional shift in the second direction y has occurred, as illustrated in FIG. 17, the movable housing 30 displaces in the second direction y with respect to the fixed housing 20 while elastically deforming the first contact 10 in the second direction y following the position of the housing 50. At this time, the first contacts 10 of either the first row R1 and the second row R2 (first row R1 in the example of FIG. 17) are deformed in the direction in which the fixing retaining portion 10B and the movable retaining portion 10C move closer to each other, and the first contacts 10 of the other row (second row R2 in the example of FIG. 17) are deformed in the direction in which the fixing retaining portion 10B and the movable retaining portion 10C move away from each other.

With enlargement of the floating range, contact between parts of the first contact 10 and contact between the first contact 10 and the fixed housing 20 are avoided even if the elastic deformation amount of the first contact 10 is large. For example, as with the first contacts 10 of the first row R1 illustrated in FIG. 17, when the first contacts 10 are deformed in the direction in which the fixing retaining portion 10B and the movable retaining portion 10C move closer to each other, the first bent portion B1 of the first zone 101 and the second bent portion B2 of the second zone 102 are proximate in the second direction y. However, the first bent portion B1 and the second bent portion B2 do not come into contact as the position in the mating direction z is different. Thus, an excessively large stress can be avoided from generating on the first contact 10 by collision between parts of the first contact 10, and lowering in signal transmission characteristics by contact energization between parts of the first contact 10 can be avoided.

Furthermore, when the fixing retaining portion 10B and the movable retaining portion 10C move closer to each other by a constant distance or more in the second direction y, the first zone 101 is inclined with respect to the mating direction z, so that the first curved portion C1 side of the first zone 101 moves closer to the side wall 21 of the fixed housing 20 with respect to the fixing retaining portion 10B side. However, since a chamfered portion 212 having a shape that follows the direction of the inclination of the first zone 101 at this time is formed on the inner side of the side wall 21 of the fixed housing 20, the first zone 101 does not come into contact with the fixed housing 20. Then a state in which the first contact 10 is separated from the housings 20, 30 excluding a predetermined part such as the fixing retaining portion 10B and the movable retaining portion 10C can be maintained. Therefore, an excessively large stress can be avoided from generating in the first contact 10 due to collision with the fixed housing 20, and impedance matching of the transmission path can be satisfactorily maintained.

The first connector 1 and the second connector 4 allows a positional shift amount corresponding to a predetermined floating range in the first direction x, the second direction y, and the xy rotating direction based on the first gap G1 and the second gap G2. At the time of mating of the first connector 1 and the second connector 4, the movable housing 30 is guided in the second direction y by the action of the inclined surface 321B of the guide protrusion 321 and the second guide inclined surface 59 of the housing 50, so that an approximate position in the second direction y is determined, and thereafter, it is positioned in the second direction y with respect to the housing 50 by the action of the guide inclined surface 31C and the guide inclined surfaces 512, 522. Thus, the movable housing 30 and the housing 50 can be smoothly mated.

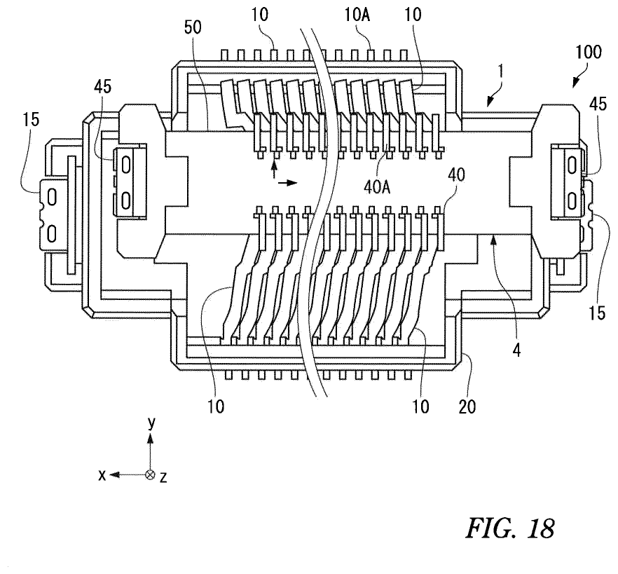

Furthermore, FIG. 18 shows a state in which positional shift between the first connector 1 and the second connector 4 has occurred in both the first direction x and the second direction y. In this case as well, the movable housing 30 displaces with respect to the fixed housing 20 and the housing 50 by the action of the guide inclined surface 31C and the guide inclined surfaces 512, 522 following the action of the inclined surfaces 321A, 321B and the guide inclined surfaces 55, 59 of the guide protrusion 321 within the range of the floating range. Accompanying therewith, each first contact 10 is elastically deformed in the first direction x and the second direction y.

Other than the above, configurations noted in the above embodiment may be optionally selected or appropriately changed to other configurations without deviating from the gist of the present invention. The joining target to which the first contact 10 is joined is not necessarily limited to the circuit board. Similarly, the joining target of the second contact 40 is also not necessarily limited to the circuit board. The opposing portion 251 formed in the fixed housing 20 and the a part of the movable housing 30 positioned between the opposing portion 251 and a reference surface (first mounting surface 61A) of the joining target is not limited to the above embodiment, and can be appropriately configured. Furthermore, the first gap G1 is not only set between the opposing portion 251 and the concave portion 323 as in the above embodiment, and may set between the movable housing 30 and the fixed housing 20 at a position separated from the opposing portion 251 and the concave portion 323. The second gap G2 is also not only set between the side walls 322A, 322B of the expansion region 32 and the side walls 252A, 252B of the expansion wall 25 as in the above embodiment, and may be set between the movable housing 30 and the fixed housing 20 at a position separated from the expansion region 32 and the expansion region 25.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A contact, comprising:
a press-fitting portion adapted to be press-fitted to a press-fitting target in a press-fitting direction;
a pushing protrusion projecting out to one side in a width direction intersecting the press-fitting direction on a back side of the press-fitting portion in the press-fitting direction, the pushing protrusion projects out beyond a position of the press-fitting portion to the one side in the width direction, a pushing surface on the back side of the pushing protrusion is opened to the back side in the press-fitting direction; and
a first widened width region continuing on the back side of the pushing protrusion, the first widened width region is located closer to another other side in the width direction with respect to the press-fitting portion, and is wider in the width direction than the press-fitting portion.

2. The contact according to claim 1, wherein the first widened width region is curved to a convex shape toward the back side.

3. The contact according to claim 2, further comprising a second widened width region continuing to a side opposite to the pushing protrusion side of the first widened width region.

4. The contact according to claim 3, wherein the second widened width region is located closer to the one side in the width direction with respect to the first widened width region, and is wider in the width direction than the press-fitting portion.

5. The contact according to claim 1, wherein a transitioning portion including a portion that is narrower in the width direction than the pushing protrusion and the first widened width region is interposed between the pushing protrusion and the first widened width region.

6. The contact according to claim 1, further comprising a first retaining portion retained by a first housing, the first housing discrete from a second housing defining the press-fitting target.

7. The contact according to claim 6, further comprising a second retaining portion including the press-fitting portion and the pushing protrusion and being retained by the second housing.

8. The contact according to claim 7, wherein the first retaining portion is press-fitted to the first housing in the same direction as the press-fitting direction of the press-fitting portion.

9. The contact according to claim 8, wherein a first curved portion curved to a convex shape toward a front side is formed on the first retaining portion side between the first retaining portion and the second retaining portion.

10. The contact according to claim 9, wherein a second curved portion curved to a convex shape toward the back side in the press-fitting direction is formed on the second retaining portion side between the first retaining portion and the second retaining portion.

11. The contact according to claim 10, further comprising:
a first zone extending from the first retaining portion to the first curved portion toward the front side in the press-fitting direction; and
a second zone extending from the first curved portion toward the back side and continuing to the second retaining portion through the second curved portion.

12. The contact according to claim 11, further comprising a third zone extending from the second retaining portion to a connecting portion connected to a mating contact toward the front side.

13. The contact according to claim 12, wherein:
the first zone is formed with a first bent portion formed to a convex shape toward the second zone; and
the second zone is formed with a second bent portion formed to a convex shape toward the first zone on the front side of the position of the first bent portion in the press-fitting direction.

14. A connector, comprising:
a plurality of contacts, each contact including:
a press-fitting portion adapted to be press-fitted to a press-fitting target in a press-fitting direction;
a pushing protrusion projecting out to one side in a width direction intersecting the press-fitting direction on a back side of the press-fitting portion in the press-fitting direction, the pushing protrusion projects out beyond a position of the press-fitting portion to the one side in the width direction, a pushing surface on the back side of the pushing protrusion is opened to the back side in the press-fitting direction; and
a first widened width region continuing on the back side of the pushing protrusion, the first widened width region is located closer to another other side in the width direction with respect to the press-fitting portion, and is wider in the width direction than the press-fitting portion, the plurality of contacts being arrayed along the width direction and forming a first row and a second row in parallel;
a first housing; and
a second housing defining the press-fitting target.

15. The connector according to claim 14, wherein the first housing retains the plurality of contacts together with the second housing and supports the second housing by way of the contacts.

16. The connector according to claim 15, wherein the second housing divides an inner side of the first housing into a first row side and a second row side.

17. The connector according to claim 16, wherein the second housing is displaceable in the width direction and a direction intersecting both the width direction and the press-fitting direction with respect to the first housing.

18. The connector according to claim 14, wherein a clearance of greater than or equal to 60% of a plate thickness of the pushing protrusion defined between the pushing protrusions of the contacts positioned in the width direction.

19. The connector according to claim 14, wherein the first row and the second row are adjacent in a thickness direction of the contact orthogonal to both the width direction and the press-fitting direction.

20. The connector according to claim 19, wherein a chamfered portion that separates in the thickness direction with respect to the first zone while moving closer to the first curved portion from the first retaining portion is formed on an inner wall of the first housing.
